(19) United States
(12) Patent Application Publication
(10) Pub. No.: US 2016/0060135 A1
(43) Pub. Date: Mar. 3, 2016

(54) Reverse Osmosis Water Purification Method and System Thereof

(71) Applicant: Genese Intelligent Technology Co., Ltd., Kaohsiung (TW)

(72) Inventor: Jung-Pei Huang, Kaohslung (TW)

(21) Appl. No.: 14/790,611

(22) Filed: Jul. 2, 2015

(30) Foreign Application Priority Data
Aug. 26, 2014 (TW) 103129427

(51) Int. Cl. C02F 1/00; B01D 61/12; C02F 1/44

(52) U.S. Cl. CPC C02F 1/008; C02F 1/441; B01D 61/12; C02F 2209/40; C02F 2209/445; C02F 2209/03; B01D 2311/14

(57) ABSTRACT

A RO water purification system includes a RO pressure pump, a motor and a microprocessor control unit and a method thereof includes: providing the motor in the RO pressure pump; utilizing the microprocessor control unit to control the motor and to measure at least one motor operation data; utilizing the motor operation data to calculate inflow water pressure data and outflow water pressure data; utilizing the inflow water pressure data and outflow water pressure data to adjust the operation of the motor for enhancing the efficiency of systematic operation.

### BACKGROUND OF THE INVENTION

1. Field of the Invention

The present invention relates to a reverse osmosis (RO) water purification method and system thereof. Particularly, the present invention relates to the reverse osmosis water purification automatic control method and system thereof. More particularly, the present invention relates to the smart reverse osmosis water purification method and system thereof.

2. Description of the Related Art

U.S. Pat. No. 6,436,282, entitled “Flow Control Module for RO Water Treatment,” discloses a reverse osmosis water purification system. A unitary multi-function control module for the reverse osmosis water purification system provides all of the necessary flow control functions in a single removable and easily replaceable unit. The module connects directly with a unitary injection molded manifold and includes a control housing having a cover plate, a main body, and a closure plate. The control housing entirely encloses therein the supply flow shutoff valve, the reverse osmosis flow control, the permeate back flow check valve, and all of the interconnections between the manifold and the supply, permeate, and brine flow paths.

Furthermore, Taiwanese Pat. Publication No. 334849, entitled “RO Water Quality, Inflow and Outflow Control Structure,” discloses a reverse osmosis water purification system having a control structure. The control structure includes a pre-filter, a water inlet valve, a high-pressure pump, a first filter, a second filter, a third filter, a RO filter, a post-filter and a control circuit. The control circuit includes a main power supply control system, a filter auto-washing system and a water quality-monitoring system. The water quality-monitoring system includes a water inflow probe and a pure water probe. The water inflow probe and the pure water probe are applied to detect impurity contained in untreated water and pure water for calculating a specific value in the filter auto-washing system. If the specific value is abnormal, a washing loop is actuated to wash the removed impurity in the RO filter. The main power supply control system includes a liquid level switch and a low-pressure valve for controlling the water inlet valve and the high-pressure pump. When an inflow pressure detected by the low-pressure valve is normal and a low level of a reservoir detected by the liquid level switch is low, the water inlet valve is open and the high-pressure pump is operated. When the inflow pressure becomes low, the water inlet valve is closed and the operation of the high-pressure pump stops.

Another Taiwanese Pat. Publication No. 387270, entitled “Improvement in Pressure Control Structure of RO Device,” discloses a pressure control structure of a reverse osmosis water purification system. The pressure control structure includes a low-pressure switch, a check valve device and a wastewater outflow limiting conduit. The check valve device connects with a wastewater inflow conduit and further connects with the wastewater outflow limiting conduit. The check valve device includes a pressure control system which further includes a bevel stopper, a membrane valve and a spring member. A pressure of a water inflow conduit controls the check valve device in a constantly recessed state such that a T-shaped stopper constantly and tightly presses a microcontroller button in the low-pressure switch. The membrane valve further connects with the T-shaped stopper for controlling it. When water supply stops or the pressure of the water inflow conduit decreases, the spring member rebounds to release the T-shaped stopper for actuating the microcontroller button to cut off power supply.

Another Taiwanese Pat. Publication No. 391306, entitled “Pressure Control Device of RO Tube,” discloses a pressure control device of a RO tube system. The pressure control device includes a pressure gauge, a RO tube and a pump. A power source supplies a voltage to the pump via a step-down adjuster and a transformer in order. According to the indication of the pressure gauge, an output pressure of the pump is adjusted to avoid overpressure output.

Another Taiwanese Pat. Publication No. 494795, entitled “Improvement in Control Circuit of RO Water Purification System,” discloses a control circuit of a reverse osmosis water purification system. The control circuit includes a power supply unit, a water-source/full-level detection unit, a pressure boost unit and an auto-control washing unit. When supplying untreated water, the water-source/full-level detection unit detects whether a water level is full. If the water level is not full, a water-source/full-level control switch actuates an inflow solenoid valve and a pressure boost motor. The auto-control washing unit is applied to preset a washing time to actuate a washing solenoid valve for washing a reverse osmosis membrane. In full level, the water-source/full-level control switch shuts down the pressure boost motor and the inflow solenoid valve to stop producing pure water.

Another Taiwanese Pat. Publication No. M254265, entitled “Auto Control Structure of RO Water Purification System,” discloses a reverse osmosis water purification system having an IC control box. The IC control box includes a drive circuit to connect a low-pressure switch and an inflow solenoid valve which are provided between first, second, third filters and a pressure boost motor. A RO filter connects with a pure water detection member and a high-pressure switch. Usage data of the first, second, third filters are calculated in the IC control box and pure water data are detected by the pure water detection member to thereby control the inflow solenoid valve and the pressure boost motor. The first, second, third filters are controlled by the IC control box according to the calculations of durable days or flow rates while the RO filter is controlled by the pure water detection member according to the calculations of total dissolved solids (TDS) in the pure water.

However, various reverse osmosis water purification systems disclosed in U.S. Pat. No. 6,436,282, Taiwanese Pat. Publication No. 334849, No. 387270, No. 391306, No. 494795 and No. M254265 have a drawback of complicated structures. In addition, the maintenance of accessories (over useful life of filters) of the conventional RO system must be manually recorded and calculated. The conventional RO system provided with an inflow control valve and an outflow control valve does not provide an operational safety mechanism responsible for improper operation, including improper or excessive use of RO filters, for example.

Hence, there is a need of providing a smart function of the RO water purification system to simplify the entire structure or to further calculate overdue maintenance time and useful lifetime of accessories, including a RO filter part or other filter parts. The above-mentioned patent is incorporated herein by reference for purposes including, but not limited to, indicating the background of the present invention and illustrating the situation of the art.

As is described in greater detail below, the present invention provides a reverse osmosis water purification method and system thereof. A RO pressure pump is provided a motor which is detected and controlled by a microprocessor control unit to generate motor operating data. The motor operating data is calculated to generate at least one of filter flow velocity data, filter flow rate data, filter's useful life data, inflow pressure data and outflow pressure data for smart control and maintenance. Advantageously, the present invention can accomplish the smart control function and can avoid providing an inflow control valve (low pressure valve) and an outflow control valve (high pressure valve) in such a way as to mitigate and overcome the above problem.

### SUMMARY OF THE INVENTION

The primary objective of this invention is to provide a reverse osmosis water purification method and system thereof. A RO pressure pump is provided with a motor which is detected and controlled by a microprocessor control unit to generate motor operating data. In operation, the motor operating data is calculated to generate at least one of filter flow velocity data, filter flow rate data, filter's useful life data, inflow pressure data and outflow pressure data for smart control and maintenance. Advantageously, the reverse osmosis water purification method and system of the present invention is successful in providing a smart control function to enhance the operational safety and the efficiency of systematic operation.

The reverse osmosis water purification method in accordance with an aspect of the present invention includes:

providing a RO pressure pump with at least one motor;

connecting a microprocessor control unit with the at least one motor for controlling RO filtering operation and to further detect or measure at least one of motor operating data;

calculating the at least one of motor operating data to generate at least one of calculated data; and

continuing, adjusting or stopping the RO filtering operation of the at least one motor according to the at least one of calculated data.

In a separate aspect of the present invention, the at least one of calculated data includes filter flow velocity data, filter flow rate data, filter's useful life data, inflow pressure data, outflow pressure data or combination thereof.

In a further separate aspect of the present invention, the motor is a DC motor or a DC brushless motor.

In yet a further separate aspect of the present invention, the microprocessor control unit electrically connects with an operational panel.

In yet a further separate aspect of the present invention, the at least one of motor operating data includes motor speed data, motor current data or combination thereof.

In yet a further separate aspect of the present invention, the at least one of motor operating data is applied to calculate a motor-overload diagnosis value or a motor-idle-running diagnosis value.

In yet a further separate aspect of the present invention, the microprocessor control unit further connects with an additional motor for controlling the RO filtering operation and to detect or measure at least one of motor operating data of the additional motor.

In yet a further separate aspect of the present invention, the RO pressure pump connects with a plurality of filter members and a RO filter member or a plurality of RO filter members.

The reverse osmosis water purification system in accordance with an aspect of the present invention includes:

a RO pressure pump provided in a RO filter device;

at least one motor provided in the RO pressure pump; and

a microprocessor control unit connecting with the at least one motor for controlling RO filtering operation and to further detect or measure at least one of motor operating data;

wherein the at least one of motor operating data is calculated to generate at least one of calculated data and the RO filtering operation of the at least one motor continues, adjusts to a new operation state or stops according to the at least one of calculated data.

In a separate aspect of the present invention, the at least one of calculated data includes filter flow velocity data, filter flow rate data, filter's useful life data, inflow pressure data, outflow pressure data or combination thereof.

In a further separate aspect of the present invention, the motor is a DC motor or a DC brushless motor.

In yet a further separate aspect of the present invention, the microprocessor control unit electrically connects with an operational panel.

In yet a further separate aspect of the present invention, the at least one of motor operating data includes motor speed data, motor current data or combination thereof.

In yet a further separate aspect of the present invention, the at least one of motor operating data is applied to calculate a motor-overload diagnosis value or a motor-idle-running diagnosis value.

In yet a further separate aspect of the present invention, the microprocessor control unit further connects with an additional motor for controlling the RO filtering operation and to detect or measure at least one of motor operating data of the additional motor.

In yet a further separate aspect of the present invention, the RO pressure pump connects with a plurality of filter members and at least one RO filter member or a plurality of RO filter members.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a reverse osmosis water purification method in accordance with a preferred embodiment of the present invention.

FIG. 2 is a flowchart of an operational control method of the reverse osmosis water purification method in accordance with the preferred embodiment of the present invention.

FIG. 3 is a block diagram of a reverse osmosis water purification system in accordance with a preferred embodiment of the present invention.

FIG. 4 is a schematic view of the reverse osmosis water purification system in accordance with the preferred embodiment of the present invention.

### DETAILED DESCRIPTION OF THE INVENTION

It is noted that a reverse osmosis water purification method and system in accordance with the preferred embodiment of the present invention can be applicable to various digital auto-control RO water purification methods and systems or other water purification methods and systems for residential use, commercial use or industrial use, for example, which are not limitative of the present invention.

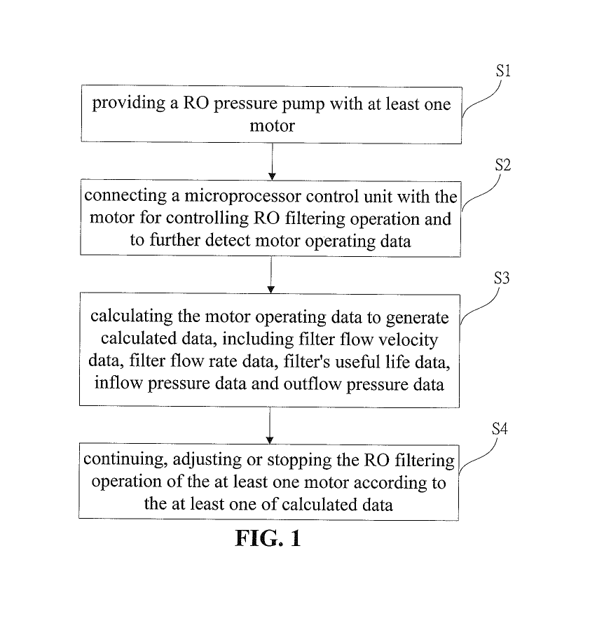

FIG. 1 shows a block diagram of a reverse osmosis water purification method in accordance with a preferred embodiment of the present invention. Referring now to FIG. 1, the reverse osmosis water purification method of the preferred embodiment of the present invention includes at least four steps of first step S1, second step S2, third step S3 and fourth step S4, which are not limitative of the present invention.

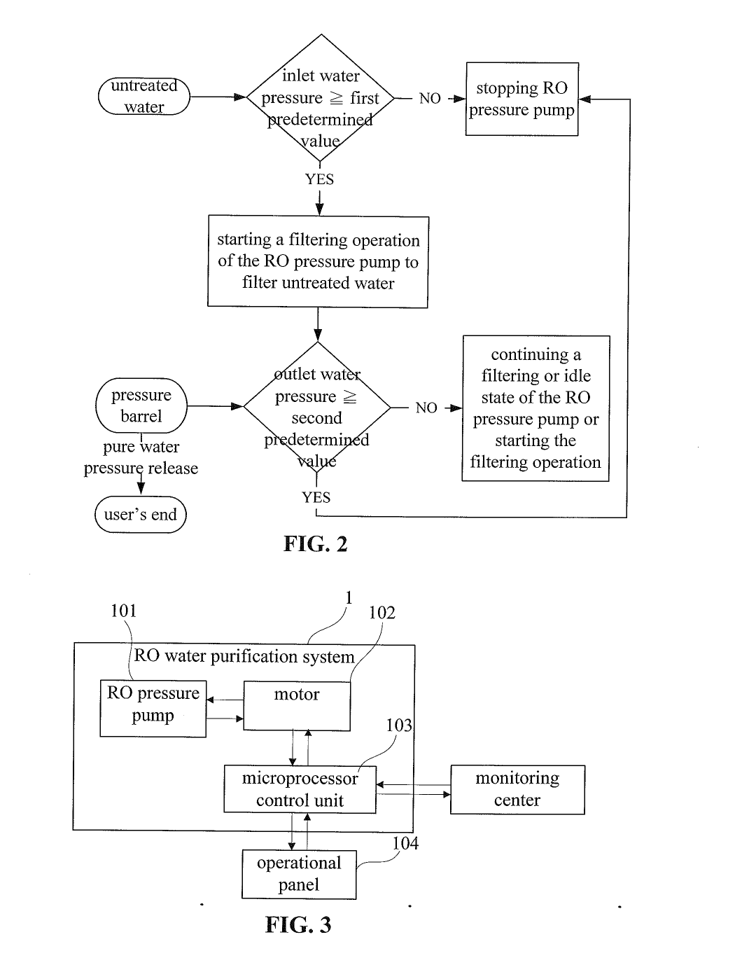

FIG. 2 shows a flowchart of an operational control method of the reverse osmosis water purification method in accordance with the preferred embodiment of the present invention corresponding to FIG. 1. Referring now to FIG. 2, the operational control method of the preferred embodiment of the present invention includes a plurality of logical control blocks of a smart control function for enhancing the operational safety and the efficiency of systematic operation.

FIG. 3 shows a block diagram of a reverse osmosis water purification system in accordance with a preferred embodiment of the present invention suitable for executing the methods shown in FIGS. 1 and 2. Referring now to FIG. 3, the reverse osmosis water purification system 1 of the preferred embodiment of the present invention includes a RO pressure pump 101, at least one motor 102, a motor micro control unit 103 and an operational panel 104 which are suitably disposed in the reverse osmosis water purification system 1 to form a RO filter control unit. Accordingly, the RO filter control unit controllably operates the reverse osmosis water purification system 1 and peripherals thereof.

With continued reference to FIG. 3, by way of example, the reverse osmosis water purification system 1 of the preferred embodiment of the present invention is provided between an untreated water supply unit and a pure water supply unit. The untreated water supply unit may be supplied from various water sources of underground water, running water, well water, river water, polluted water, sea water or other fresh water sources. A useful life time of RO filters or other type filters are different due to different water quality of aforementioned water sources. The pure water supply unit may be installed in kitchens, laboratories, water stations, pure water factories or other pure water supply places.

Referring now to FIGS. 1 to 3, the reverse osmosis water purification method of the preferred embodiment of the present invention includes the step S1 of: providing the RO pressure pump 101 with the at least one motor 102 which generates motive power to operate the RO pressure pump 101 and the peripherals (e.g. RO filter member). The motor 102 is selected from a DC motor, a DC brushless motor or other type motors. By way of example, the specifications of the motor 102 applied in the RO pressure pump 101 are as follows: a 24V DC motor with a motor current ranging between 0.15 A to 0.8 A, a maximum motor current not greater than 1.0 A and a motor speed (unloaded) ranging between 650 to 700 RPM.

With continued reference to FIGS. 1 to 3, the reverse osmosis water purification method of the preferred embodiment of the present invention includes the step S2 of: connecting the microprocessor control unit 103 with the at least one motor 102 for automatically controlling a series of RO filtering operation with logical control or ceasing the RO filtering operation in case it is necessary. Furthermore, the microprocessor control unit 103 is operated to detect or measure at least one of motor operating data of the motor 102 for adjustably controlling operation (i.e. motor speed), starting, restarting or stopping (i.e. cutting off power supply).

By way of example, the motor operating data include motor speed data, motor current data (i.e. motor load current data) or other operational data or operational states. The motor operating data is applied to calculate a motor-overload diagnosis value or a motor-idle-running diagnosis value. Furthermore, the microprocessor control unit 103 electrically connects with the operational panel 104 for transmitting various motor operating data of continuing, adjusting, starting, stopping, emergency stopping (for changing filter), emergency stop alarm or other motor operating data and operation states which are displayed on the operational panel 104. In a preferred embodiment, the reverse osmosis water purification system 1 can be preset via the operational panel 104 according to various water qualities.

With continued reference to FIGS. 1 to 3, the reverse osmosis water purification method of the preferred embodiment of the present invention includes the step S3 of: calculating the at least one of motor operating data with caliber data of the reverse osmosis water purification system 1 to generate at least one of calculated data by the microprocessor control unit 103 or other reserved or spare operation units. By way of example, the calculated data include filtering flow velocity data and filtering flow rate data (i.e. total flow rate data). Accordingly, the microprocessor control unit 103 is capable of calculating estimated data of the operational state of the RO filter and an amount of producing pure water.

With continued reference to FIGS. 1 to 3, the reverse osmosis water purification method of another preferred embodiment of the present invention includes the step S3 of: calculating the at least one of motor operating data particularly with various water quality data and caliber data of the reverse osmosis water purification system 1 to generate at least one of useful lifetime data of filter parts by the microprocessor control unit 103 or other operation units. By way of example, the filter parts include RO filter members and other filter members. Accordingly, the microprocessor control unit 103 is capable of estimating the operational state and residual useful lifetime data of the RO filter member.

With continued reference to FIGS. 1 to 3, the reverse osmosis water purification method of another preferred embodiment of the present invention includes the step S3 of: calculating the at least one of motor operating data (e.g. motor speed or motor current) particularly with various statistic method (e.g. linear least square method or nonlinear least square method) to obtain inflow or outflow water pressure data by the microprocessor control unit 103 or other operation units. In a preferred embodiment, the inflow or outflow water pressure data of two opposite ends of the RO filter member are also calculated. Suppose that the calculated inflow or outflow water pressure data are estimation of inflow or outflow water pressure data of the reverse osmosis water purification system 1.

With continued reference to FIGS. 1 to 3, as the outflow water pressure of the reverse osmosis water purification system 1 increases, the motor speed of the motor 102 decreases and the motor load current also increases. The decrease of the motor speed data and the increase of the motor load current data are sent to calculate the outflow water pressure data by the microprocessor control unit 103 or other operation units.

With continued reference to FIGS. 1 to 3, conversely, as the inflow water pressure of the reverse osmosis water purification system 1 decreases, the motor speed of the motor 102 increases and the motor load current also decreases. The increase of the motor speed data and the decrease of the motor load current data are sent to calculate the inflow water pressure data by the microprocessor control unit 103 or other operation units.

With continued reference to FIGS. 1 to 3, after the reverse osmosis water purification system 1 operates for a predetermined useful lifetime of RO filtering operation as well as exhaustion of the RO filter member, a reverse osmosis membrane of the RO filter member is completely choked. In this circumstance, if the motor 102 continuously runs to pump water, an inner pressure of pipelines of the reverse osmosis water purification system 1 (at a water inlet side of the RO filter member) will result in continuously increasing. Disadvantageously, it may cause blow out or water leakage of the pipelines of the reverse osmosis water purification system 1.

With continued reference to FIGS. 1 to 3, the blow out or water leakage of the pipelines of the reverse osmosis water purification system 1 occurs possibly if the inflow water pressure drops abruptly in filtering operation. In order to avoid the occurrence of blow out or water leakage of pipelines, the microprocessor control unit 103 or other operation units is selectively operated to display the residual useful lifetime of the filter parts and alarm signals thereof on the operational panel 104. In a preferred embodiment, in order to enhance the operational safety, the microprocessor control unit 103 further controls immediately stopping the operation of the motor 102 and prevents restarting it till the filter part changes.

With continued reference to FIGS. 1 to 3, the reverse osmosis water purification method of another preferred embodiment of the present invention includes the step S4 of: continuing, adjusting, stopping (cutting off power supply) or restarting the RO filtering operation of the at least one motor 102 by the microprocessor control unit 103 or other operation units according to the at least one of calculated data, including filter flow velocity data, filter flow rate data, filter's useful life data, inflow pressure data, outflow pressure data or combination thereof. In a preferred embodiment, the calculated data of filter flow velocity data, filter flow rate data, filter's useful life data, inflow pressure data and outflow pressure data and operational states are sent to a monitoring center or a cloud server in FIG. 3.

Referring back to FIGS. 2 and 3, the operational control method of the reverse osmosis water purification method of the present invention includes the step of: operating the microprocessor control unit 103 to start a filtering operation of the RO pressure pump 101 and the motor 102 if the inlet water pressure is greater than a first predetermined value (low pressure value). Conversely, the microprocessor control unit 103 controls stopping (forcing shutdown) the filtering operation of the RO pressure pump 101 and the motor 102 or preventing a restart operation of them if the inlet water pressure is lower than the first predetermined value.

Still referring to FIGS. 2 and 3, the operational control method of the reverse osmosis water purification method of the present invention further includes the step of: operating the microprocessor control unit 103 to continue a filtering or idle state of the RO pressure pump 101 and the motor 102 or to start the filtering operation of them if the outlet water pressure is lower than a second predetermined value (high pressure value). Conversely, the microprocessor control unit 103 controls stopping (forcing shutdown) the RO pressure pump 101 and the motor 102 or preventing the restart operation of them if the outlet water pressure is greater than the second predetermined value.

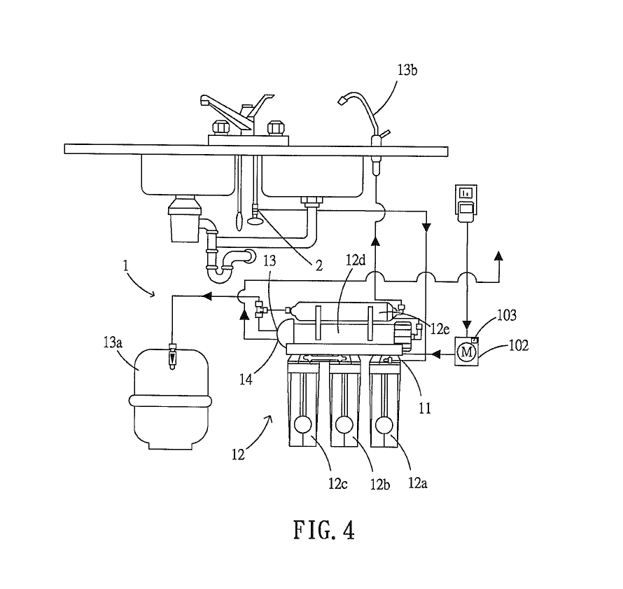

FIG. 4 shows a schematic view of the reverse osmosis water purification system in accordance with the preferred embodiment of the present invention corresponding to FIGS. 1 to 3. Referring to FIG. 4, the reverse osmosis water purification system 1 of the preferred embodiment of the present invention is installed in a kitchen sink for residential use. The reverse osmosis water purification system 1 connects with a running water supply 2 and includes a water inlet 11, a RO filter unit 12, a pure water outlet 13 and a RO waste water outlet 14. The motor 102 and the microprocessor control unit 103 are suitably combined in the reverse osmosis water purification system 1 and electrically connect to the RO filter unit 12, as best shown in right portion of FIG. 4.

Still referring to FIG. 4, the water inlet 11 of the reverse osmosis water purification system 1 connects with the running water supply 2. The water inlet 11 is located at a first side of the RO filter unit 12 while the pure water outlet 13 and the RO waste water outlet 14 are located at a second side of the RO filter unit 12. The RO filter unit 12 includes a first filter member 12a, a first active carbon filter member 12b, a second filter member 12c, at least one RO filter member 12d and a second active carbon filter member 12e which are serially combined and have different useful lifetime in filtering operation.

With continued reference to FIG. 4, the reverse osmosis water purification system 1 further includes a pressure barrel 13a or a water tank for reservoiring pure water. The pure water outlet 13 and the pressure barrel 13a connect with a faucet (tap) 13b for supplying pure water and further electrically connect with the motor 102 and the microprocessor control unit 103 or the operational panel 104. The pure water outlet 13 and the pressure barrel 13a connect with the faucet 13b via the second active carbon filter member 12e.

With continued reference to FIG. 4, by way of example, the reverse osmosis water purification system 1 of another preferred embodiment omits the arrangement of the pressure barrel 13a or water tank. In a preferred embodiment, the reverse osmosis water purification system 1 includes a plurality of pressure barrels 13a or water tanks according to different needs.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. A reverse osmosis water purification method comprising:
providing a RO pressure pump with at least one motor;
connecting a microprocessor control unit with the at least one motor for controlling RO filtering operation and to further detect or measure at least one of motor operating data;
calculating the at least one of motor operating data to generate at least one of calculated data; and
continuing, adjusting or stopping the RO filtering operation of the at least one motor according to the at least one of calculated data.

2. The reverse osmosis water purification method as defined in claim 1, wherein the at least one of calculated data includes filter flow velocity data, filter flow rate data, filter's useful life data, inflow pressure data, outflow pressure data or combination thereof.

3. The reverse osmosis water purification method as defined in claim 1, wherein the motor is a DC motor or a DC brushless motor.

4. The reverse osmosis water purification method as defined in claim 1, wherein the microprocessor control unit electrically connects with an operational panel.

5. The reverse osmosis water purification method as defined in claim 1, wherein the at least one of motor operating data includes motor speed data, motor current data or combination thereof.

6. The reverse osmosis water purification method as defined in claim 1, wherein the at least one of motor operating data is applied to calculate a motor-overload diagnosis value or a motor-idle-running diagnosis value.

7. The reverse osmosis water purification method as defined in claim 1, wherein the microprocessor control unit further connects with an additional motor for controlling the RO filtering operation and to detect or measure at least one of motor operating data of the additional motor.

8. The reverse osmosis water purification method as defined in claim 1, wherein the RO pressure pump connects with a plurality of filter members and a RO filter member or a plurality of RO filter members.

9. A reverse osmosis water purification system comprising:
a RO pressure pump provided in a RO filter device;
at least one motor provided in the RO pressure pump; and
a microprocessor control unit connecting with the at least one motor for controlling RO filtering operation and to further detect or measure at least one of motor operating data;
wherein the at least one of motor operating data is calculated to generate at least one of calculated data and the RO filtering operation of the at least one motor continues, adjusts to a new operation state or stops according to the at least one of calculated data.

10. The reverse osmosis water purification system of the as defined in claim 9, wherein the at least one of calculated data includes filter flow velocity data, filter flow rate data, filter's useful life data, inflow pressure data, outflow pressure data or combination thereof.

11. The reverse osmosis water purification system of the as defined in claim 9, wherein the motor is a DC motor or a DC brushless motor.

12. The reverse osmosis water purification system of the as defined in claim 9, wherein the microprocessor control unit electrically connects with an operational panel.

13. The reverse osmosis water purification system of the as defined in claim 9, wherein the at least one of motor operating data includes motor speed data, motor current data or combination thereof.

14. The reverse osmosis water purification system of the as defined in claim 9, wherein the at least one of motor operating data is applied to calculate a motor-overload diagnosis value or a motor-idle-running diagnosis value.

15. The reverse osmosis water purification system of the as defined in claim 9, wherein the microprocessor control unit further connects with an additional motor for controlling the RO filtering operation and to detect or measure at least one of motor operating data of the additional motor.

16. The of the as defined in claim 9, wherein the RO pressure pump connects with a plurality of filter members and a RO filter member or a plurality of RO filter members.

17. An operational control method of a reverse osmosis water purification system comprising:
operating a microprocessor control unit to start a filtering operation of a RO pressure pump if an inlet water pressure is greater than a first predetermined value;
further operating the microprocessor control unit to controllably stop the filtering operation of the RO pressure pump if the inlet water pressure is lower than the first predetermined value;
yet further operating the microprocessor control unit to continue a filtering or idle state of the RO pressure pump or to start the filtering operation of the RO pressure pump if an outlet water pressure is lower than a second predetermined value; and
yet further operating the microprocessor control unit to controllably stop the RO pressure pump if the outlet water pressure is greater than the second predetermined value.

18. The operational control method of the as defined in claim 17, wherein the inlet water pressure and the outlet water pressure are calculated from motor operating data by the microprocessor control unit.

19. The operational control method of the as defined in claim 17, wherein the microprocessor control unit is operated to controllably prevent a restart operation of the RO pressure pump if the inlet water pressure is lower than the first predetermined value.

20. The operational control method of the as defined in claim 17, wherein the microprocessor control unit is operated to controllably prevent a restart operation of the RO pressure pump if the outlet water pressure is greater than the second predetermined value.
